(19) United States
(12) Patent Application Publication
(10) Pub. No.: US 2001/0021215 A1
(43) Pub. Date: Sep. 13, 2001

(54) Compact ultra fast laser

(76) Inventors: Udo Bunting, Gotzis (AT); Daniel Kopf, Altach (AT)

Correspondence Address: OLIFF & BERRIDGE, PLC, P.O. Box 19928, Alexandria, VA, 22320, US

(21) Appl. No.: 09/768,167

(22) Filed: Jan. 24, 2001

Related U.S. Application Data
(63) Continuation of application No. 09/489,964, filed on Jan. 24, 2000.
(60) Provisional application No. 60/146,472, filed on Jul. 30, 1999.

(51) Int. Cl. H01S 3/091

(52) U.S. Cl. 372/70

(57) ABSTRACT

The solid state laser comprises a laser gain medium, pumping means for pumping the laser gain medium, and a laser cavity having a first end and a second end, wherein the laser gain medium is at, or in the vicinity of, said first end of said cavity. A semiconductor saturable absorber mirror (SESAM) can be placed at the second end of the cavity. The laser gain medium can comprise at least one face for receiving pumping energy from the pumping means, the face being made reflective at a laser frequency of the laser, so that it can form the first end of the laser cavity. The resulting setup can used for generating femtosecond laser pulses.

### FIELD OF THE INVENTION

This invention relates to compact solid state lasers.

### BACKGROUND OF THE INVENTION

Femtosecond lasers are usually more complicated than other lasers emitting continuouswave, Q-switched, or picosecond radiation. One reason for this is that femtosecond generation requires laser materials with a spectrally broad emission band, in comparison for example to the well-known laser material Nd:YAG, leaving a limited number of laser materials suitable for femtosecond generation. Additionally, femtosecond lasers need some group velocity dispersion compensation, which usually requires additional intra cavity elements, such as a prism pair, thereby adding complexity to the system. An example of a femtosecond laser is the green-pumped Ti:sapphire laser. More compactness is obtained by directly diode pumping suitable laser materials, such as Nd:glass, Cr:LiSAF, Yb:glass, etc (see for example in D. Kopf, et al., “Diode-pumped modelocked Nd:glass lasers using an A-FPSA”, Optics Letters, vol. 20, pp. 1169-1171, 1995; D. Kopf, et al., “Diode-pumped 100-fs passively modelocked Cr:LiSAF using an A-FPSA”, Optics Letters, vol. 19, pp. 2143-2145, 1994; C. Honninger, et al., “Femtosecond Yb:YAG laser using semiconductor saturable absorbers”, Optics Letters, vol. 20, pp. 2402-2405, 1995). These laser systems, however, are not perfectly compact in the sense that they usually use two laser diodes as pump sources that are imaged into the laser crystal using imaging optics. The latter are relatively large in size and could still be made considerably more compact. Furthermore, the resonator comprises two arms that have to be aligned accurately with respect to each other and with respect to the pump beam, respectively, resulting in a number of high-accuracy adjustments to be performed. Quite commonly, focusing lenses with a focal length of 75 mm or longer are used to focus the pump light into the laser crystal through one of the curved cavity mirrors, following a delta-type laser cavity scheme. Such a cavity scheme essentially does not allow for straight-forward size reduction of the pump optics. Another approach (see for example S. Tsuda, et al., “Low-loss intracavity AlAs/AlGaAs saturable Bragg reflector for femtosecond mode locking in solid-state lasers”, Optics Letters, vol. 20, pp. 1406-1408, 1995) places the laser medium at the end of the laser cavity, thereby allowing for more compact pump focusing optics with a potentially shorter working distance and reducing the number of adjustments required. However, since one cavity end is taken by the laser medium, both the semiconductor element (semiconductor saturable absorber mirror, SESAM) and the prism sequence for dispersion compensation need to be placed toward the other end of the laser resonator. Since the spot size on the SESAM needs to be small enough for saturation in that setup, the focusing mirror towards that cavity end does not leave enough room for a prism pair to compensate for the group velocity dispersion. However a total of four prisms had to be implemented for that purpose.

### SUMMARY OF THE INVENTION

The invention comprises a compact solid state laser. The laser medium is positioned at or close to one end of the laser cavity and pumped by at least one pump source or laser diode. The pumping can be done by one or two laser diodes including imaging optics of compact size (10 cm or less), respectively, due to the arrangement of the cavity end and pumping optics, and is suitable for achieving reasonable gain even from low-gain laser materials. For femtosecond operation, the laser resonator is laid out such that both a semiconductor saturable absorber mirror and a prism pair are located toward the other end of the cavity, and the laser mode on the SESAM and the prism sequence length fulfill the requirements that have to be met for stable femtosecond generation. It is another object of the invention to provide a semiconductor saturable absorber mirror (SESAM) having a structure which comprises a plurality of alternating gallium arsenide (GaAs) and aluminum arsenide (AlAs) or Aluminum gallium arsenide (AlGaAs) layers, each layer having an optical thickness corresponding substantially to one quarter wavelength, a gallium arsenide (GaAs) substrate at a first face of said plurality of alternating layers, a gallium arsenide (GaAs) or AlGaAs structure integrating an absorber layer at a second face of said plurality of alternating layers, and plurality of dielectric layers at a face of said gallium arsenide (GaAs) opposite the one in contact with said second face, whereby the overall structure shows resonant behaviour. Such a SESAM may be implemented into a solid state laser as described above. It is a further object of the invention to provide a special setup for a solid state laser, wherein the laser comprises a laser gain medium, pumping means for pumping said laser gain medium, a laser cavity with a semiconductor saturable absorber mirror (SESAM) at one end of said cavity, and wherein said cavity contains a prism pair followed by a telescope.

### BRIEF DESCRIPTION OF THE DRAWINGS

The invention and its advantages shall become more apparent from reading the following description of the preferred embodiments, given purely by way of non-limiting illustrative examples with reference to the appended drawings, in which:

FIG. 1 is a schematic representation of a laser gain setup according to a preferred embodiment of the invention;

FIG. 2 is a schematic representation of an unfolded propagation of the laser mode cavity of a femtosecond cavity;

FIG. 3 is a schematic representation of an implementation of the cavity of FIG. 2 forming a small-size setup;

FIGS. 4a and 4b are schematic representations of implementations of the cavity of FIG. 2 with a relatively larger prism sequence, followed by an intracavity telescope and the cavity end.

FIG. 5 shows an example of a semiconductor saturable absorber structure which can be used in combination with prism sequences.

### DETAILED DESCRIPTION OF THE PREFERRED EMBODIMENTS

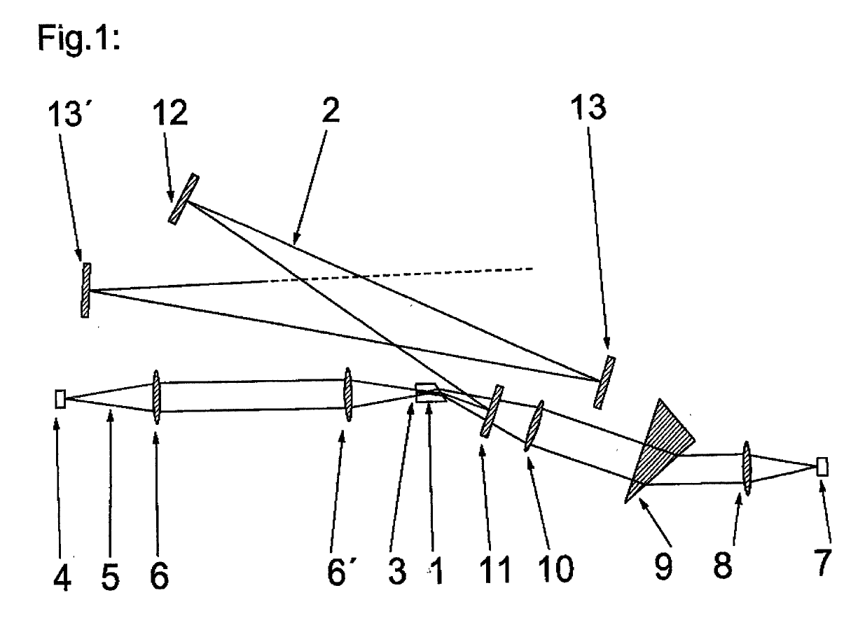

The general setup of a compact, ultra-fast laser according to a preferred embodiment of the invention shall be described with reference to FIG. 1. The gain section of the laser setup comprises a laser gain medium 1 which is located in the vicinity of a first end of a laser cavity (see laser cavity mode axis 2). The laser gain medium 1 can even be the laser cavity end itself if one side 3 of the laser material is coated for reflectivity at the laser wavelength. A flat-brewster-cut laser medium may be used, where the flat side is coated for reflectivity at the laser wavelength and for high transmission at the wavelength of the pump laser diode 4 used in the setup. The laser diode beam is preferably collimated in the (vertical) fast-divergent axis by means of a cylindrical micro lens attached close to the laser diode 4 so that the pump beam 5 diverges at a reduced vertical divergence angle. The pump laser diode 4 can be for example a 100 micron wide laser diode emitting at a power of 1 or more Watts at a wavelength of 800 nm. It serves to pump a laser medium such as Nd:glass. A collimating lens 6 and focusing lens 6′ are used to re-image the pump beam into the laser medium 1. Imaging elements including the microlens, and lenses 6 and 6′ may be replaced by any imaging optics of similar compactness and imaging properties. Because of the potentially short working distance between lens 6′ and the laser medium 1, the pump elements 4,6,6′ can cover as short a distance, on the order of 10 cm or less.

The setup uses a second pump source comprising a laser diode 7, collimating lens 8, prism 9, focusing lens 10, and dichroic mirror 11. The pump beam of laser diode 7 is first collimated with lens 8 and then enters prism 9. When the beam emerges from the prism 9, it has been expanded in the tangential plane, as indicated in FIG. 1. This results in a smaller spot in air after focusing lens 10. One or the other of these laser diodes, or both combined, may produce a pump intensity of 10 kW per square centimeter or more. When entering the laser medium 1 through the Brewster face, however, the spot will be expanded again due to the Brewster face refraction. Therefore the prism 9 is used to pre-compensate the expansion due to the Brewster face, which results in similar spot sizes within the laser medium 1 from both pump sources. Additionally, the prism 9 is used to compensate for the beam axis angle due to the Brewster face of the laser medium. The pump source comprising laser diode 7, lens 8, prism 9, and lens 10 can have a degree of compactness similar to that of the first pump source, assuming that dichroic mirror 11 is placed close enough to the laser medium 1, reducing the working distance between the lens 10 and the laser medium. The dichroic mirror 11 is highly transmissive for the pump wavelength of laser diode 7 and highly reflective for the laser wavelength. In this way, the resonator mode 2 is directed from the laser medium 1 towards a curved cavity mirror 12 and some further plane folding mirrors 13 and 13′, etc., for example. When the focus spot of the pump sources 4 and 7 is chosen to be located within the laser medium 1, this pump arrangement is suitable for pumping low-gain laser materials such as Nd:glass, Cr:LiSAF, Yb:glass, Yb:YAG, Yb:KGW, etc (low-gain meaning less gain than Nd:YAG). This pump arrangement can therefore be used for pumping broad emission band laser materials suitable for femtosecond generation. It may however also be used for pumping any solid state laser material for other purposes including continuous wave, Q-switched, or picosecond operation.

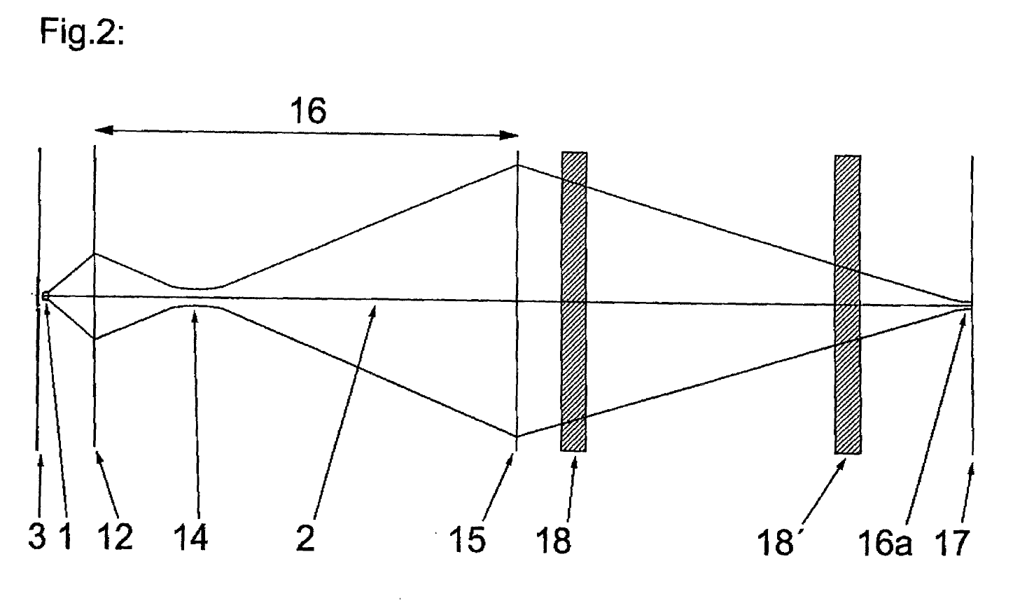

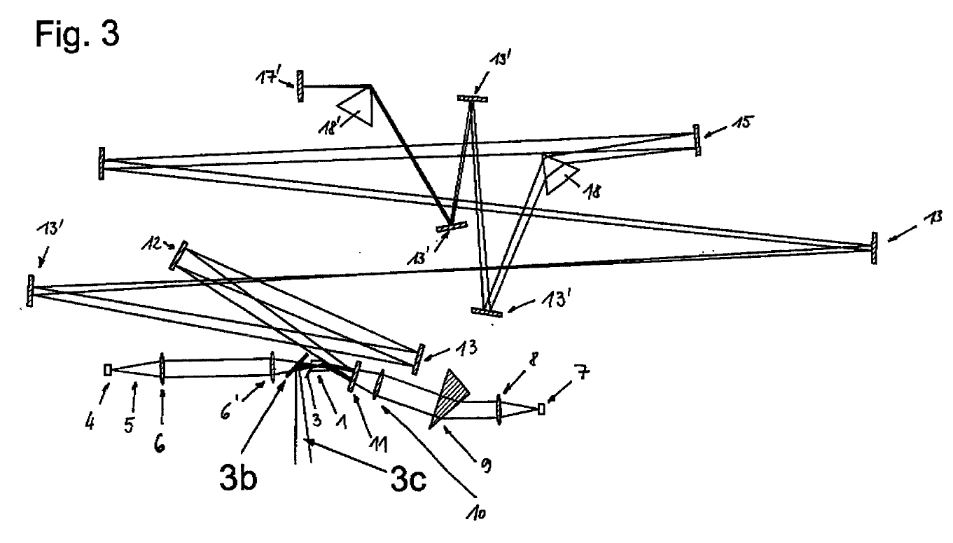

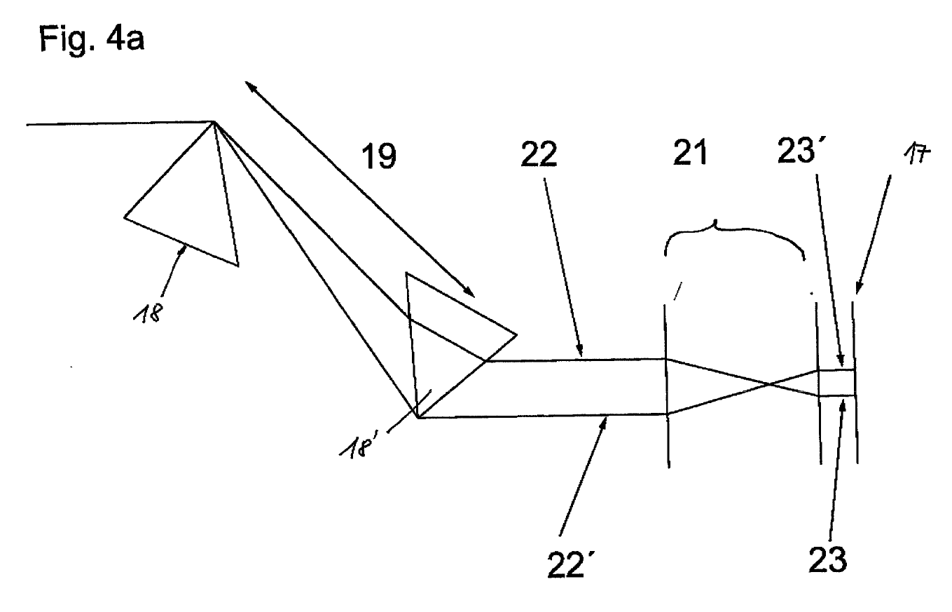

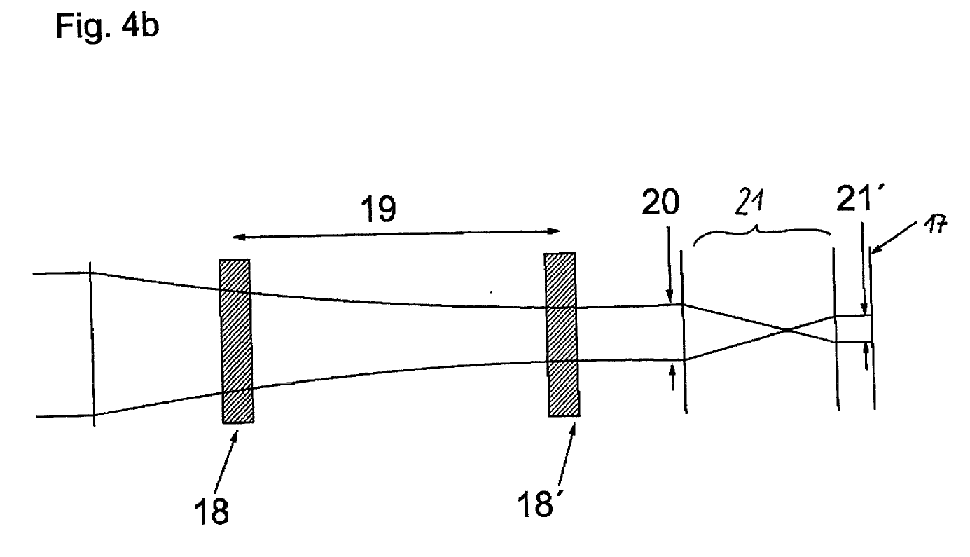

For a femtosecond laser setup, above setup can be combined with the laser mode shown in FIG. 2, which illustrates an example of an unfolded propagation of the laser mode throughout a possible femtosecond cavity. The lenses indicate curved cavity mirrors that refocus the cavity mode. Laser medium 1 in the vicinity of one cavity end 3′ has a mode radius on the order of 30×45 um (microns). The cavity end 3′ may be a mirror with characteritsic features similar to thoses of the coated side 3 of the laser material in FIG. 1. Curved mirror 12 (whose radius of curvature is for example 200 mm) is located some 120 mm away from the laser medium 1, and therefore re-images the cavity mode into a waist 14. The cavity mode then further diverge to a spot size that is on the order of 2-3 mm in diameter at another cavity mirror 15 (whose radius of curvature is for example 600 mm) after a distance 16 of around 1400 mm. The relatively large mode diameter at cavity mirror 15 results in a small mode diameter 16a at the laser cavity end which contains a SESAM (semiconductor saturable absorber mirror) 17. An example of a design for a suitable SESAM is given in D. Kopf, et al., “Diode-pumped femtosecond solid state lasers based on semiconductor saturable absorbers”, SPIE Proceedings, “Generation, Amplification and Measurement of Ultrashort Laser Pulses III”, 28-30 January 1996, San Jose, Calif., The International Society for Optical Engineering). This laser cavity has a large working distance of around 400 mm between element 15 and 17 such that it can contain a prism pair 18,18′ (shown schematically, see also FIG. 4b) consisting of two SF10 Brewster prisms that are separated by some 350 mm for sufficient group velocity dispersion compensation. The cavity of FIG. 2 can be folded with plane highly reflective mirrors at any location as required to fit the setup into small boxes. One example of a final small-size setup is shown in FIG. 3. Here the surface 3 of the laser medium 1 is made partially transmissive for the laser wavelength such that a fraction of the intracavity power is outcoupled and furthermore separated from the incident pump beam by dichroic mirror 3b, resulting in laser output beam 3c. Prism sequences that are considerably longer than those in above setup can be achieved at the expense of a larger spot size at the end of the prism sequence.

FIGS. 4a and 4b illustrate such examples of prism sequences. For such longer prism sequences 19, for example 500-1000 mm long or longer, the spot size 20 at the SESAM could be too large for achieving saturation at femtosecond operation as required for stable ultra fast performance. To solve this problem, it can be useful to extend the cavity by a telescope 21. In this way, the mode size reduces according to the telescope factor to a mode size 21′ (FIG. 4a), where the SESAM is positioned. Simultaneously, the parallelism between two dispersed beams 22 and 22″ is preserved after the telescope, and corresponding beams 23 and 23′ (FIG. 4a) are perpendicular to the end mirror (which is the SESAM) 24 as required for the lasing condition and for obtaining negative group velocity dispersion from the prism sequence 19. Prism sequences of considerable length can also be used in combination with a special SESAM structure such that saturation is obtained at lower energy densities for stable ultra fast laser operation.

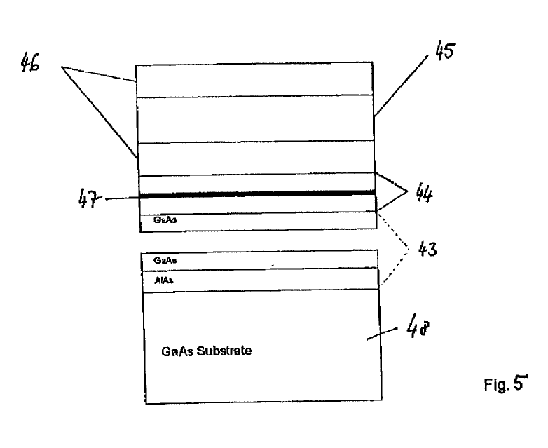

FIG. 5 shows an example of such a semiconductor saturable absorber structure, representing the layers along the surface normal to its surface. Firstly, 30 pairs of layers of alternating gallium arsenide (GaAs) and aluminium arsenide (AlAs) layers 43 each with an optical thickness corresponding to a quarter wavelength are applied onto a gallium arsenide (GaAs) substrate 48. This can be achieved by means of growth process using molecular beam epitaxy (MBE). However, other known epitaxy processes and usual in this field are also suitable. The GaAs/AlAs pairs of layers are transparent for the laser wavelength of 1064 nm and result, in the example of FIG. 5, in a Bragg mirrorlike coating structure with a high reflection factor close to 100% with a wavelength of 1064 nm if the thickness of GaAs is selected at approx. 72.3 nm and that of AlAs at approx. 88 nm, each corresponding to about an optical quarter wavelength. Then, a further GaAs layer 44 integrating an approx. 10 nm thin absorber layer of indium gallium arsenide (InGaAs) material is assembled onto this standard GaAs/AlAs Bragg mirror structure. The optical total thickness of this GaAs layer with integrated absorber layer 47 corresponds to half a wavelength, that is the physical film thickness is approx. 145 nm. The indium content of the absorber layer 47 is determined so that an absorption is obtained at the laser wavelength of 1064 nm, that is the band-edge is approx. 1064 nm or a few 10 nm higher than the laser wavelength, e.g. at 1064-1084 nm. This corresponds to an indium content of about 25 percent. With higher intensity and pulse energy density, a saturation of the absorption of this absorber layer 47 occurs, i.e. it is lower. In the case of particularly thin layers of less than 20 nm thickness, by additionally finely adjusting the indium content, the exciton peak near the band edge, generated by the exciton absorption behaviour of thin layers to be quantizised, can be adjusted exactly to the laser wavelength, resulting again in an even more pronounced saturable absorption at that wavelength. Finally, another three or more pairs of dielectric layers transparent for the layer wavelength are applied, beginning with that layer 45 having a higher index of refraction n=2.02 and continuing with that layer 46 having a lower index of refraction of 1.449 at a wavelength of 1064 nm. The process of electron beam coating, widespread in the optical coating field, is suitable to achieve this. Other optical coating processes, such as for example ion beam sputtering, are also suitable and can have the advantage of resulting in lower losses. As optical layer materials, those with an index of refraction of 1.449 and 2.02 at a wavelength of 1064 nm were used. However, a large number of other materials can be used as long as adhesion to GaAs and transparency at the laser wavelength are ensured. Because the three or more final dielectric pairs have a reversed order in terms of their index of refraction, with respect to the order of the refractive indexes of the layers underneath, the structure is at resonance. By virtue of the resonant saturable absorber mirror structure, this device has a saturation fluence which can be on the order of a few microjoules per square centimeter (depending on the number of dielectric top layers), which is considerably lower than those of existing SESAMs, and can therefore be well suited for femtosecond or pulsed laser generation from setups where the laser mode on the saturable absorber device is usually too large for saturation. Thanks to the resonant structure, one single or a low number of single thin saturable absorber layers introduce an increased saturable absorption for the overall device in comparison to those structures which do not use a resonant structure. When the saturable absorber layers introduce strain due to a lattice mismatch (which is the case for Indium Gallium Arsenide within GaAs), this structure helps reduce strain without reducing the saturable absorption effect for the overall device, resulting in less material defects and in improved long-term properties of the device.

While there has been described herein the principles of the invention, it is to be clearly understood to those skilled in the art that this description is made only by way of example and not as a limitation to the scope of the invention. Accordingly, it is intended, by the appended claims, to cover all modifications which fall within the spirit and scope of the invention.

What is claimed is:

1. A solid state laser comprising a laser gain medium, pumping means for pumping said laser gain medium, and a laser cavity having a first end and a second end, wherein said laser gain medium is at, or in the vicinity of, said first end of said cavity.

2. The solid state laser of claim 1, further comprising a semiconductor saturable absorber mirror (SESAM) at said second end of said cavity.

3. The solid state laser of claim 1, wherein said cavity is a femtosecond cavity.

4. The solid state laser according to claim 1, wherein said laser gain medium comprises at least one face for receiving pumping energy from said pumping means, said face being made reflective at a laser frequency of said laser, whereby said laser gain medium forms said first end of said laser cavity.

5. The solid state laser according to claim 4, wherein said at least one face is a flat face of a flat-Brewster-cut laser gain medium.

6. The solid state laser according to claim 1, further comprising a collimating lens and a focusing lens to re-image said first pump beam into said laser medium, with a working distance less than 50 mm

7. The solid state laser according to claim 1, wherein said pumping means comprises first and second pumping sources, each producing a pumping beam at respective faces of said laser gain medium.

8. The solid state laser according to claim 7, wherein an optical path from said second pumping source to said laser gain medium comprises a collimating lens, a prism, a focusing lens and a dichroic mirror.

9. The solid state laser according to claim 7, wherein an optical path from a said pumping source to said laser gain medium is on the order of 10 centimeters or less.

10. The solid state laser according to claim 1, wherein at least one beam spot from said pumping means is located within said laser gain medium.

11. The solid state laser according to claim 1 wherein said laser gain medium has a composition taken from the group comprising: Nd:glass, Cr:LiSAF, Yb:glass, Yb:YAG, Yb:KGW.

12. The solid state laser according to claim 1 wherein said laser gain medium has a composition having a gain equal to or smaller than a gain obtained from the composition Yb:YAG, gain to be determined as the product of the stimulated emission cross section and the upper laser level life time.

13. The solid state laser according to claim 1 wherein said laser gain medium is a broad emission band laser material suitable for femtosecond laser generation.

14. The solid state laser according to claim 1, wherein said laser gain medium at a cavity end has a mode radius on the order of 30 microns×45 microns.

15. The solid state laser according to claim 1, wherein the pumping means have a pump intensity equal to or greater than 10 kW per square centimeter.

16. The solid state laser according to claim 1, further comprising a first curved mirror at an output of said laser gain medium arranged to re-image a cavity mode into a waist.

17. The solid state laser according to claim 16, further comprising a second curved mirror between said waist and said second end of said cavity.

18. The solid state laser according to claim 17, wherein a distance between said second curved mirror and said second end of said cavity is on the order of 40 centimeters or longer to contain a prism pair for group velocity dispersion compensation.

19. The solid state laser according to claim 17, further comprising a prism pair between said second curved mirror and said second end of said cavity for group velocity dispersion compensation.

20. The solid state laser according to claim 1, wherein the working distance of said cavity is folded by highly reflective mirror means for integration in a compact setup application.

21. The solid state laser according to claim 1, wherein said cavity contains a prism pair followed by a telescope.

22. The solid state laser according to claim 2, wherein said SESAM is a layered structure comprising:
a plurality of alternating gallium arsenide (GaAs) and aluminum arsenide (AlAs) or Aluminum gallium arsenide (AlGaAs) layers, each layer having an optical thickness corresponding substantially to one quarter wavelength,
a gallium arsenide (GaAs) substrate at a first face of said plurality of alternating layers,
a gallium arsenide (GaAs) or AlGaAs structure integrating an absorber layer at a second face of said plurality of alternating layers, and
plurality of dielectric layers at a face of said gallium arsenide structure (GaAs) opposite the one in contact with said second face,
whereby the overall structure shows resonant behaviour.

23. The solid state laser according to claim 1 where said cavity contains a prism pair followed by the structure of claim 22.

24. Use of the laser according to claim 1 for generating femtosecond laser pulses.

25. Use of the laser according to claim 1 for continuous wave or Q-switched laser operation.

26. A semiconductor saturable absober mirror (SESAM) for a solid-state laser, said semiconductor saturable absober mirror having a layered structure comprising:
a plurality of alternating gallium arsenide (GaAs) and aluminum arsenide (AlAs) or Aluminum gallium arsenide (AlGaAs) layers, each layer having a thickness corresponding substantially to one quarter wavelength,
a gallium arsenide (GaAs) substrate at a first face of said plurality of alternating layers,
a gallium arsenide (GaAs) structure integrating an absorber layer at a second face of said plurality of alternating layers, and
plurality of dielectric layers at a face of said gallium arsenide structure (GaAs) opposite the one in contact with said second face,
whereby the overall structure shows resonant behaviour.

27. The semiconductor saturable absober mirror of claim 26, wherein said plurality of alternating gallium arsenide (GaAs) and aluminium arsenide (AlAs) or Aluminum gallium arsenide (AlGaAs) layers is on the order of 30 in number.

28. The semiconductor saturable absober mirror of claim 26, wherein each of said plurality of gallium arsenide (GaAs) and aluminium arsenide (AlAs) or Aluminum gallium arsenide (AlGaAs) layers has a thickness respectively of approximately 72.3 nanometers and approximately 88 nanometers.

29. The semiconductor saturable absober mirror of claim 26, wherein a total optical thickness of said gallium arsenide (GaAs) structure integrating an absorber layer corresponds to half a wavelength.

30. The semiconductor saturable absober mirror of claim 26, wherein said dielectric layers are three or more in number.

31. The semiconductor saturable absober mirror of claim 30, wherein said dielectric layers have a reversed order in terms of their index of refraction, with respect to the order of the refractive indexes of the layers underneath, thereby forming a resonant structure.

32. A solid state laser comprising a laser gain medium, pumping means for pumping said laser gain medium, and a laser cavity having a first end and a second end, and a semiconductor saturable absorber mirror (SESAM) located toward one said end of said cavity, said semiconductor saturable absorber mirror comprising:
a plurality of alternating gallium arsenide (GaAs) and aluminum arsenide (AlAs) or Aluminum gallium arsenide (AlGaAs) layers, each layer having a thickness corresponding substantially to one quarter wavelength,
a gallium arsenide (GaAs) substrate at a first face of said plurality of alternating layers,
a gallium arsenide (GaAs) structure integrating an absorber layer at a second face of said plurality of alternating layers, and
plurality of dielectric layers at a face of said gallium arsenide structure (GaAs) opposite the one in contact with said second face,
whereby the overall structure shows resonant behaviour.

33. The solid state laser of claim 32, wherein said cavity is a femtosecond cavity.

34. The solid state laser according to claim 32. wherein said laser gain medium has a composition taken from the group comprising: Nd:glass, Cr:LiSAF, Yb:glass, Yb:YAG, Yb:KGW.

35. The solid state laser according to claim 32. wherein said laser gain medium has a composition having a gain smaller than a gain obtained from the composition Nd:YAG.

36. The solid state laser according to claim 32, wherein said laser gain medium is a broad emission band laser material suitable for femtosecond laser generation.

37. The solid state laser according to claim 32, further comprising a first curved mirror at an output of said laser gain medium arranged to re-image a cavity mode into a waist.

38. The solid state laser according to claim 37, further comprising a second curved mirror between said waist and said second end of said cavity.

39. The solid state laser according to claim 38, wherein a distance between said second curved mirror and said second end of said of said cavity is on the order of 40 centimeters.

40. The solid state laser according to claim 38, further comprising a prism pair between said second curved mirror and said second end of said cavity for group velocity dispersion compensation.

41. The solid state laser according to claim 32, wherein said plurality of alternating gallium arsenide (GaAs) and aluminium arsenide (AlAs) or Aluminum gallium arsenide (AlGaAs) layers is on the order of 30 in number.

42. The solid state laser according to claim 32, wherein each of said plurality of gallium arsenide (GaAs) and aluminium arsenide (AlAs) or Aluminum gallium arsenide (AlGaAs) layers has a thickness respectively of approximately 72.3 nanometers and approximately 88 nanometers.

43. The solid state laser according to claim 32, wherein a total optical thickness of said gallium arsenide (GaAs) structure integrating an absorber layer corresponds to half a wavelength.

44. The solid state laser according to claim 32, wherein said dielectric layers are three or more in number.

45. The solid state laser according to claim 44, wherein said dielectric layers have a reversed order in terms of their index of refraction, with respect to the order of the refractive indexes of the layers underneath, thereby forming a resonant structure.

46. A solid state laser comprising a laser gain medium, pumping means for pumping said laser gain medium, a laser cavity with a semiconductor saturable absorber mirror (SESAM) at one end of said cavity, said cavity containing a prism pair followed by a telescope.
